(19) United States
(12) Patent Application Publication
(10) Pub. No.: US 2011/0074836 A1
(43) Pub. Date: Mar. 31, 2011

(54) DISPLAY DRIVER CAPABLE OF SELECTIVELY PROVIDING GAMMA CORRECTION AND DISPLAY APPARATUS USING SAME

(75) Inventors: DENG-TZUNG TANG, Miao-Li County (TW); AN SHIH, Miao-Li Country (TW)

(73) Assignee: CHIMEI INNOLUX CORPORATION, Miao-Li County (TW)

(21) Appl. No.: 12/890,694

(22) Filed: Sep. 26, 2010

(30) Foreign Application Priority Data
Sep. 29, 2009 (CN) 200910307999.3

(51) Int. Cl. G09G 5/10

(52) U.S. Cl. 345/690

(57) ABSTRACT

A display driver for driving a display panel includes a data selector configured to selectively output one of a preset digital code and a gamma correction value under control of a control signal; and a data processor configured to selectively perform a gamma correction operation on an RGB signal based on the information output by the data selector. When the information output to the data processor is the preset digital code, the data processor is directed to not perform gamma correction; when the information output to the data processor is the gamma correction value, the data processor is notified of the requirement for gamma correction based on the gamma correction value. A display apparatus is driven by the display driver.

### BACKGROUND

1. Technical Field

The disclosure relates to flat panel display (FPD) technology, and more particularly, to a display driver capable of selectively providing gamma correction, and a display apparatus using the display driver.

2. Description of Related Art

FPDs are widely used in various portable information products, such as notebooks, personal digital assistants, video cameras, and the like.

A typical FPD includes a display panel activated by a driver application. Due to photoelectric characteristics of a display panel, color temperature of the display panel may deviate from a desired value, which may impair display quality of the FPD.

Gamma correction is one technique that can be utilized to adjust the color temperature of the FPD. Often, a gamma correction function module can be integrated in the driver of the FPD, for example, a gamma correction table is pre-configured in the driver. When an RGB signal is provided to the driver, the driver reads a corresponding gamma correction value from the gamma correction table, and then performs a gamma correction operation on the RGB signal. Moreover, the gamma-corrected RGB signal is further converted to a data voltage, and output to the display panel to drive a pixel unit to display a corresponding picture element.

Some types of FPD, however, may not require this gamma correction capability, and may, for example, utilize other techniques for color temperature adjustment. Because the existing gamma correction function module is integrated in the driver, the driver is incompatible with FPDs without gamma correction capability. Therefore, to a display apparatus manufacturer, different drivers must be prepared to meet different requirements of gamma correction capability of FPDs. This complicates manufacture and management thereof.

What is needed, therefore, is an LCD that can overcome the described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is a block diagram of a display apparatus according to an embodiment of the present disclosure, the display apparatus including a display driver.

FIG. 2 illustrates one embodiment of operation of the display driver and the display apparatus of FIG. 1.

### DETAILED DESCRIPTION

Reference will now be made to the drawings to describe certain exemplary embodiments of the present disclosure in detail.

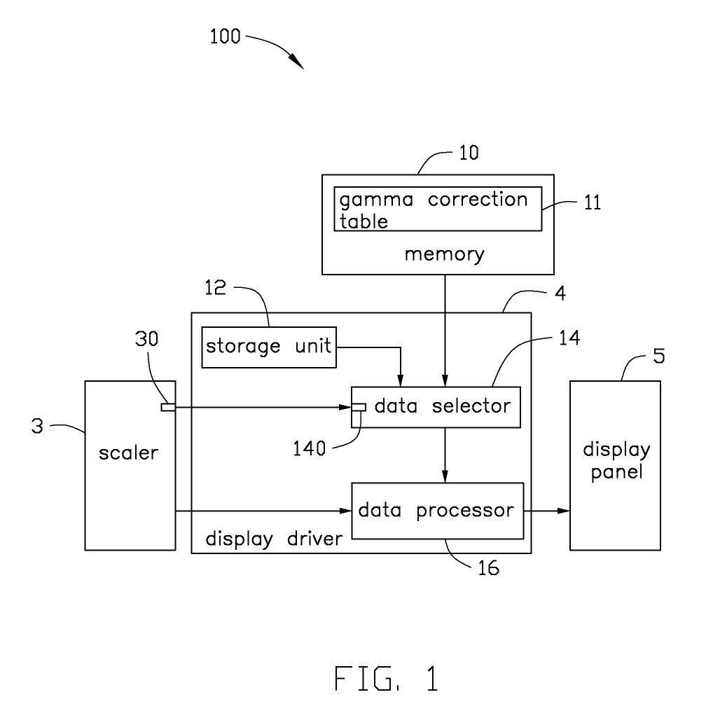

FIG. 1 is a block diagram of a display apparatus 100 according to an embodiment of the present disclosure. The display apparatus 100 may include a scaler 3, a display driver 4, a memory 10, and a display panel 5. The display driver 4 is electrically coupled between the scaler 3 and the display panel 5, and the display driver 4 is also electrically coupled to the memory 10.

The display panel 5 may be a flat display panel such as a liquid crystal panel, which is adapted to display pictures according to data signals output by the display driver 4.

The memory 10 may include a gamma correction table 11. The gamma correction table 11 includes a plurality of entries, each corresponding to a respective gray level of the display panel 5. The gamma correction table 11 is used to indicate mapping relations between the gray levels and corresponding gamma correction values. The gamma correction table 11 can be read by the display driver 4, such that the display driver 4 can perform gamma correction operations on received RGB signals according to gray levels of the RGB signals. In the illustrated embodiment, the memory 10 is an element independent from the display driver 4, it is noted, however, that in an alternative embodiment, the memory may also be integrated inside the display driver, that is, be configured as an internal element of the display driver 4.

The scaler 3 is adapted to provide scaled RGB signals to the display driver 4. The scaler 3 may also provide a control signal to the display driver 4, and the control signal is used to notify the display driver 4 of whether to perform the gamma correction operation on the received RGB signals. In one embodiment, the control signal may have a constant value, which can be preset. In an alternative embodiment, the control signal may be variable, generated by the scaler 3 according to the RGB signals output to the display driver 4.

The display driver 4 is adapted to provide data signals to the display panel 5 in accordance with a predetermined timing, and drive the display panel 5 to display pictures by use of the data signals. The data signals may be generated by the display driver 4 based on the RGB signals output from the scaler 3. Moreover, before the RGB signals are converted to the data signals, the display driver 4 may selectively perform the gamma correction operations on the RGB signals, for example, in an exemplary embodiment, the gamma correction operations can be activated or deactivated by a control signal output from the scaler 3. In addition, the display driver 4 may be a timing controller or a data driver, in the illustrated embodiment, the timing controller is used as an example.

To implement the selective performance of the gamma correction operations, in one embodiment, as shown in FIG. 1, the display driver 4 includes a data selector 14, a data processor 16, and a storage unit 12. The storage unit 12 may pre-store information about nonperformance of gamma correction, for example, a preset digital code, which may have a format similar to that of the gamma correction values of the gamma correction table 11 in the memory 10. The data selector 14 is electrically coupled to the memory 10 and the storage unit 12, and includes a control terminal 140 for receiving the control signal. The data selector 14 can receive the preset digital code from the storage unit 12 and a corresponding gamma correction value from the gamma correction table 11, and selectively output the preset digital code or the corresponding gamma correction value under the control of the control signal. The data processor 16 is adapted to selectively perform the gamma correction operation on the RGB signals according to the information output by the data selector 14, and convert the RGB signals to the data signals.

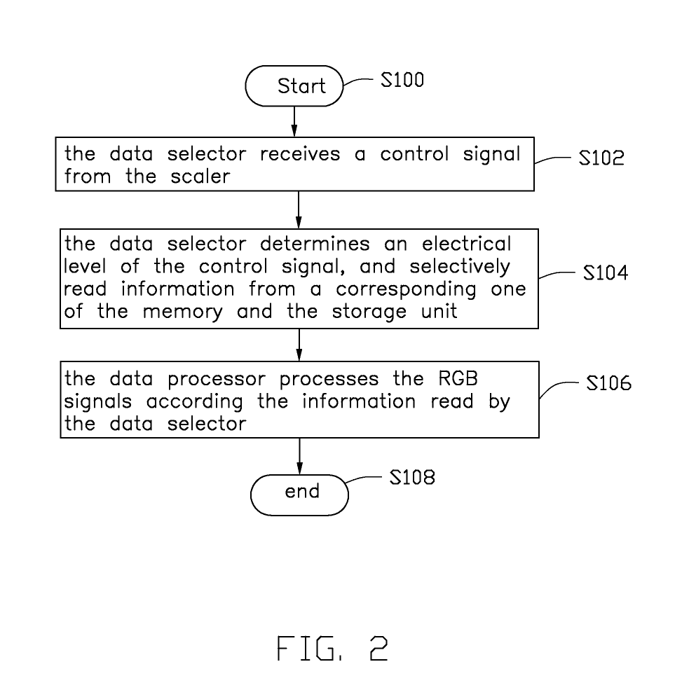

Referring to FIG. 2, in operation, firstly, the data selector 14 receives a control signal from the scaler 3 (step S102). The control signal can be a one-bit digital signal, which can be a high level voltage (represented as “1”) or a low level voltage (represented as “0”). Secondly, the data selector 14 determines an electrical level of the control signal, and selectively read information from a corresponding one of the memory 10 and the storage unit 12 (step S104). Thirdly, the data processor 16 processes the RGB signals according the information read by the data selector 14 (step S106).

In detail, when the control signal is the high level voltage (i.e., the control signal has a first value of “1”), the display driver 4 is activated to perform gamma correction. Accordingly, the data selector 14 reads a corresponding gamma correction value from the gamma correction table 11, and then outputs the gamma correction value to the data processor 16. The data processor 16 further performs a gamma correction operation on the RGB signal based on the gamma correction value, and then converts the RGB signal to a corresponding data signal, and output the data signal to the display panel 5, so as to enable the display panel to display a picture.

When the control signal is the low level voltage (i.e., the control signal has a second value of “0”), the display driver 4 is deactivated to perform the gamma correction operation. Accordingly, the data selector 14 reads the preset digital code from the storage unit 12, and then outputs the preset digital code to the data processor 16. Upon obtaining the preset digital code, the data processor 16 is directed to not perform the gamma correction operation on the RGB signal, and thus the data processor 16 directly converts the RGB signal to the data signal and outputs the data signal to the display panel 5.

In the display apparatus 100 as described, as can be seen, the memory 10, the storage unit 12, and the data selector 14 cooperatively serve as a gamma correction control module directing the data processor 16 to selectively perform the gamma correction operation on the RGB signals, in response to a control signal. In the illustrated embodiment, as above, the control signal is provided by the scaler 3, however, the control signal may alternatively be provided by other components in the display apparatus 100, such as a microprocessor unit.

It is noted that when the control signal is preset as a constant, for example, constant “1”, the display driver 4 is controlled to continue the gamma correction operation on the RGB signals once the display apparatus 100 is powered on. Similarly, when the control signal is preset as constant “0”, the display driver 4 is directed to bypass any gamma correction operation on the RGB signal.

Furthermore, in an alternative embodiment, the gamma correction table 11 may include a plurality of sub-tables. The, for example, three sub-tables may be respectively named as a first sub-table, a second sub-table, and a third sub-table. Correspondingly, the control signal output by the scaler 3 may be a 2-bit digital signal, which can be represented as (0, 0), (0, 1), (1, 0), or (1, 1). In particular, a (0, 0) control signal indicates no gamma correction operation is to be performed, accordingly, the data selector 14 reads the preset digital code from storage unit 12, and the data processor 16 directly converts the RGB signal to the data signal upon receiving the preset digital code.

A control signal of (1, 1) indicates a gamma correction value in the first sub-table is to be selected for gamma correction. Accordingly, the data selector 14 reads a gamma correction value from the first sub-table, and the data processor 16 converts the RGB signal to the data signal based on the gamma correction value selected by the data selector 14 from the first sub-table. A control signal value of (1, 0) indicates a gamma correction value in the second sub-table is to be selected for gamma correction, and a value of (0, 1) indicates a gamma correction value in the third sub-table is to be selected for gamma correction.

According to the disclosure, it can be seen that because the data processor 16 of the display driver 4 can selectively perform the gamma correction operation on the RGB signals according to the control signal, the display driver 4 can be used in a variety of display apparatuses, irrespective of whether gamma correction operation is to be performed, simplifying management of components manufacture.

It is to be further understood that even though numerous characteristics and advantages of a preferred embodiment have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A display driver for driving a display panel, comprising:
a data selector configured to receive a preset digital code and a gamma correction value and selectively output one of the preset digital code and the gamma correction value under control of a control signal, and
a data processor electrically coupled to the data selector, and configured to selectively perform a gamma correction operation on an RGB signal based on the one of the preset digital code and the gamma correction value output by the data selector;
wherein when the one of the preset digital code and the gamma correction value output to the data processor is the preset digital code, the data processor is directed to not perform the gamma correction operation; and when the one of the preset digital code and the gamma correction value output to the data processor is the gamma correction value, the data processor is notified of the requirement for the gamma correction operation based on the gamma correction value.

2. The display driver of claim 1, further comprising a storage unit, wherein the storage unit is electrically coupled to the data selector, and is configured to provide the preset digital code.

3. The display driver of claim 2, wherein the preset digital code has a format substantially the same as that of the gamma correction value.

4. The display driver of claim 1, wherein the gamma correction value is provided by a memory independent from the display driver, the memory comprising a gamma correction table pre-configured therein, the gamma correction table comprising a plurality of gamma correction values.

5. The display driver of claim 1, further comprising a memory integrated therein, wherein the memory is also electrically coupled to the data selector, and is configured to provide the gamma correction value.

6. The display driver of claim 5, wherein the memory comprises a gamma correction table, in which the gamma correction value is configured.

7. The display driver of claim 6, wherein the gamma correction table comprises a plurality of entries, each corresponding to a respective gray level, and indicating a mapping relation between the gray level and a corresponding gamma correction value.

8. The display driver of claim 6, wherein the gamma correction table comprises a plurality of sub-tables, and when the control signal directs the data selector to read a gamma correction value, the data selector selects one of the sub-tables according to a value of the control signal, and reads a corresponding gamma correction value from the selected sub-table.

9. The display driver of claim 1, wherein the control signal and the RGB signal are both provided by a scaler.

10. A display apparatus, comprising:
a display panel; and
a display driver configured to drive the display panel, the display driver comprising:
a data selector configured to receive a preset digital code and a gamma correction value and selectively output one of the preset digital code and the gamma correction value under control of a control signal; and
a data processor electrically coupled to the data selector, and configured to selectively perform a gamma correction operation on an RGB signal based on the one of the preset digital code and the gamma correction value output by the data selector;
wherein when the one of the preset digital code and the gamma correction value output to the data processor is the preset digital code, the data processor is directed to not perform the gamma correction operation; and when the one of the preset digital code and the gamma correction value output to the data processor is the gamma correction value, the data processor is notified of the requirement for the gamma correction operation based on the gamma correction value.

11. The display apparatus of claim 10, wherein the display driver further comprises a storage unit electrically coupled to the data selector, the storage unit configured to provide the preset digital code.

12. The display apparatus of claim 11, wherein the preset digital code has a format substantially the same as that of the gamma correction value.

13. The display apparatus of claim 10, further comprising a memory electrically coupled to the data selector, configured to provide the gamma correction value.

14. The display apparatus of claim 13, wherein the memory comprises a gamma correction table, in which the gamma correction value is configured.

15. The display apparatus of claim 14, wherein the gamma correction table comprises a plurality of entries, each corresponding to a respective gray level, and indicates a mapping relation between the gray level and a corresponding gamma correction value.

16. The display apparatus of claim 14, wherein the gamma correction table comprises a plurality of sub-tables, and when the control signal controls the data selector to read a gamma correction value, the data selector selects one of the sub-tables according to a value of the control signal, and then read a corresponding gamma correction value from the selected sub-table.

17. The display apparatus of claim 10, wherein the display driver further comprises a memory integrated therein, the memory being electrically coupled to the data selector, and configured to provide the gamma correction value.

18. The display apparatus of claim 10, further comprising a scaler providing both the control signal and the RGB signal.

19. The display apparatus of claim 18, wherein the control signal is preset as a constant value.

20. The display apparatus of claim 18, wherein a value of the control signal is variable, and the value is provided by the scaler according to the RGB signal output to the display driver.
